(19) United States
(12) Patent Application Publication
(10) Pub. No.: US 2005/0175958 A1
(43) Pub. Date: Aug. 11, 2005

(54) Utensil holder for dental care

(76) Inventor: Thomas Mahl, Malmkoping (SE)

Correspondence Address: NIXON & VANDERHYE, PC, 901 NORTH GLEBE ROAD, 11TH FLOOR, ARLINGTON, VA, 22203, US

(21) Appl. No.: 10/513,413

(22) PCT Filed: May 9, 2003
(86) PCT No.: PCT/IB03/01804

(30) Foreign Application Priority Data
May 10, 2002 (SE) 0201416-5

(51) Int. Cl. A61C 13/38

(52) U.S. Cl. 433/79

(57) ABSTRACT

Utensil holders for removing objects from dental-care utensils, preferably using one hand, comprising a base part designed to be placed on a substantially fixed surface, said base part having one or more first attachment members and each utensil being provided with a second attachment member. the first attachment member consists of a spring-loaded member which protrudes into a groove, and the second attachment member consists of a tongue provided with a stop which, when it is pushed into the groove is firmly locked by the spring-loaded member engaging with the stop.

### TECHNICAL FIELD

The present invention relates to a utensil holder for dental care, i.e. a holder for various types of utensils used at a dentist's place of work, for instance. The utensils may consist of various types of cups for liquids used for disinfecting, etching and the like, as well as for various types of disposable materials.

### BACKGROUND ART

At such a place of work, usually a dental chair, there is, besides equipment for drilling, cleaning the drilled hole with compressed air, taking X-rays and the like, a stand where various utensils are accessible to the dentist while treating a patient. It generally holds mugs and cups for liquid, as well as a number of other utensils in the form of relatively heavy objects, which should not be knocked off the stand by mistake. These objects are usually of a permanent nature since disposable materials are generally very light plastic objects, not provided with weights that would otherwise retain them on the table. One such object is the usual box for cotton-wool rolls from which rolls are removed through a hole in the lid of the box with the aid of tweezers. In that case, the box must be sufficiently heavy not to be pulled off the stand and fall to the floor when the cotton-wool is removed.

The object of the present invention is to provide a system for making these utensils available for retrieval with one hand, particularly utensils of a disposable nature that are generally found beside a dentist's chair, and particularly the stands normally used at such work places.

### BRIEF DESCRIPTION OF THE INVENTION

The utensil holder in accordance with the invention comprises a base part designed to be placed on a substantially fixed surface, such as a stand beside a dental chair. The base part may be permanently or temporarily attached to the stand, or it may be so heavy that it can be placed on the stand without being dislodged when an object is removed from the utensils.

The base part has one or more first attachment members to receive various utensils for a dentist, for instance, working at the work place, and hold them ready to be picked up manually. Each utensil is provided with a second attachment member and is intended for attachment on the base part by the second attachment member being brought into contact with the first attachment member. Objects can be removed from respective utensils by hand since the base part is not dislodged when the objects are removed. Similarly, utensils can be exchanged manually and the dentist is thus able to reach suitable utensils during an operation in which one hand is engaged in holding an instrument in place in the patient's mouth, for instance.

Preferably the first attachment member is arranged to cooperate with the second attachment member by means of a snap function, so that each utensil can be replaced by means of a simple manipulation. However, this does not exclude the possibility of the attachment members having a more permanent attachment function, i.e. where a base part is prepared with a certain number of different utensils, and exchanging the entire base part when a new patient is to be treated.

It lies within the scope of the invention to also utilize the base part with its accessories in the form of dental-care utensils in other ways, e.g. completely separate from a stand. Similarly, the invention may be used in activities other than dental care but involving a similar need to be able to remove various objects with one hand without the storage container or equivalent falling to the floor.

The first attachment member may consist of a spring-loaded member which protrudes into a preferably horizontal groove in the base part, while the second attachment member may consist of a tongue provided with a stop which, when it is pushed into the groove is firmly locked by the spring-loaded member in the first attachment member engaging with the stop in the second, spring-loaded member. The spring-loaded member suitably consists of a ball which is held depressed in the groove for the tongue, with the aid of a spring. In this case the stop may comprise a hole in the tongue.

In an alternative embodiment of the utensil holder in accordance with the invention, the first attachment member may consist of a tongue protruding from the base part and the second attachment member of a component having a groove with a spring-loaded member for snapping into a stop, e.g. a hole in the tongue, i.e. in principle a solution that is the reverse of that described above.

In yet another alternative embodiment of the utensil holder in accordance with the invention, the first attachment member may consist of a hole in the upper side of the base part, and the second attachment member may consist of an arm with a pin protruding downwardly therefrom, said pin being intended to be passed down through the hole and snapped fast therein.

In yet another alternative embodiment of the utensil holder the first attachment member may consist of a pin protruding upwardly from the upper side of the base part, and the second attachment member may consist of an arm with a hole intended to fit over the pin and be snapped fast thereto.

In yet another alternative embodiment of the utensil holder the second attachment member is suspended in the first attachment member by the weight of respective utensils.

In a further alternative embodiment of the utensil holder the first attachment member may consist of a spring-loaded clamp with a function like a clothes pin, in which the second attachment member, e.g. in the form of a tongue, is secured. The reverse is also feasible where the second attachment member consists of a clamp and the first of a tongue.

In yet another alternative embodiment of the utensil holder the attachment members may consist .of the parts of an attachment member in the form of a strip of Velcro tape.

Further details and features relating to the invention will become apparent in the description of the drawings and in the appended claims.

### BRIEF DESCRIPTION OF THE DRAWINGS

FIG. 1 shows a utensil holder in accordance with the invention secured on a tabletop beside a dental chair, and provided with a few utensils.

FIG. 2 shows the base part of the utensil holder shown in FIG. 1, separately, seen from one of the long edges.

FIG. 3 shows the base part as in FIG. 2, seen in a cross section along the line I-I in FIG. 2.

FIG. 4 shows the base part in FIGS. 2 and 3, seen from above.

FIG. 5 shows a utensil in the form of a dappen dish for liquid, provided with an attachment member and seen from the side.

FIG. 6 shows the dappen dish according to FIG. 5 seen from above.

FIG. 7 shows a plate with two cups for liquid, provided with an attachment member and seen from the side.

FIG. 8 shows the plate in FIG. 7 seen from above.

FIG. 9 shows a box for cotton-wool rolls, provided with an attachment member and seen from the side.

FIG. 10 shows the box in FIG. 9 seen from above.

FIG. 11 shows a plate with micro-brushes, provided with an attachment member and seen from the side.

FIG. 12 shows the plate in FIG. 11 seen from above.

FIG. 13 shows a base part in an alternative embodiment, seen from the side.

FIG. 14 shows the base part in FIG. 13 seen from above.

FIG. 15 shows a cross section through the base part in FIGS. 13 and 14 along the line II-II in FIG. 13.

### DESCRIPTION OF THE DRAWINGS

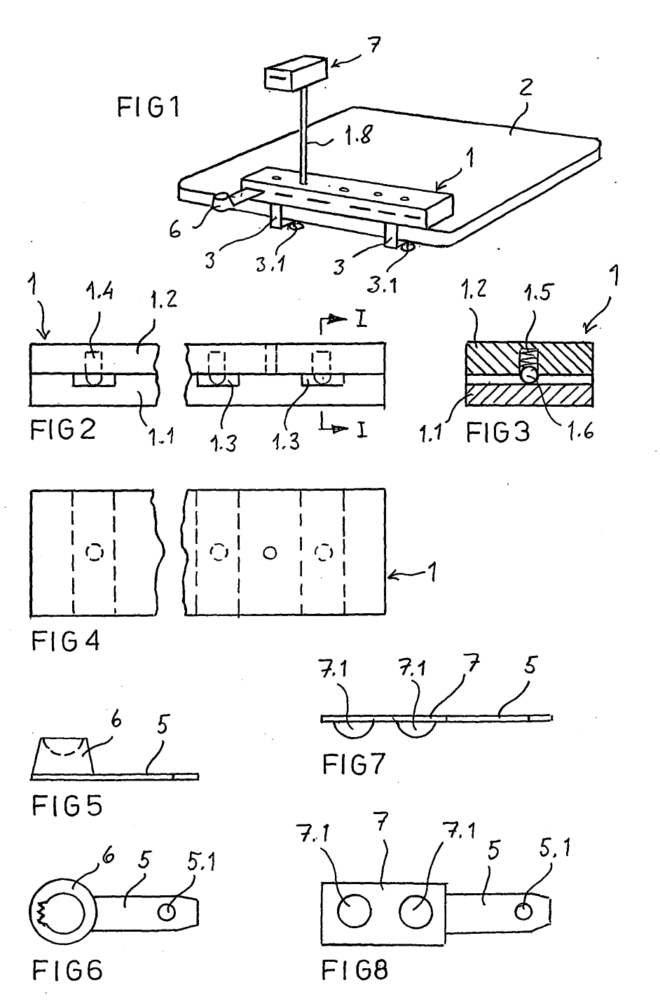

The utensil holder shown in FIG. 1 comprises a base part 1 secured to a tabletop 2 beside a dental chair with the aid of two brackets 3 provided with cramps 3.1. The base part 1 is in the shape of a right-angled prism and is shown without brackets in FIGS. 2-4. The base part 1 has a lower base part 1.1 onto which an upper base part 1.2 is secured by means of screws, not shown in the drawings.

The lower base part 1.1 is provided with grooves 1.3 extending horizontally across its upper side. At each groove the upper base part 1.2 is provided internally with a hole 1.4 in which a spring 1.5 holds a first attachment member in the form of a ball 1.6 pressed against the bottom of each groove 1.3.

The base unit 1 shown in FIG. 1 constitutes a primary unit in relation to a secondary base unit 1.7 arranged on a rod 1.8 protruding upwardly from the primary base unit 1. The secondary base unit 1.7 is provided with a groove 1.3 with a first attachment member 1.6 of the same type as in the primary base unit 1, which is able to receive a utensil.

Each utensil is intended to be attached to the base part 1 by means of a second attachment member 5, as can be seen from the examples of utensils shown in FIGS. 5-12. FIG. 5, for instance, shows a dappen dish 6 for liquid, provided with a second attachment member in the form of a tongue 5. Such a dappen dish is also shown attached to the base part 1 in FIG. 1. The tongue is provided with a hole 5.1 which is brought into contact with the ball 1.6 in the first attachment member when the tongue is inserted into the groove 1.3 in the base part 1.

An alternative embodiment of the dish 6 in FIGS. 5 and 6 is shown in FIGS. 7 and 8 where the dish is replaced by a plate 7 provided with two cups 7.1 for liquid. Here, also, the second attachment member consists of a tongue 5 with a hole 5.1.

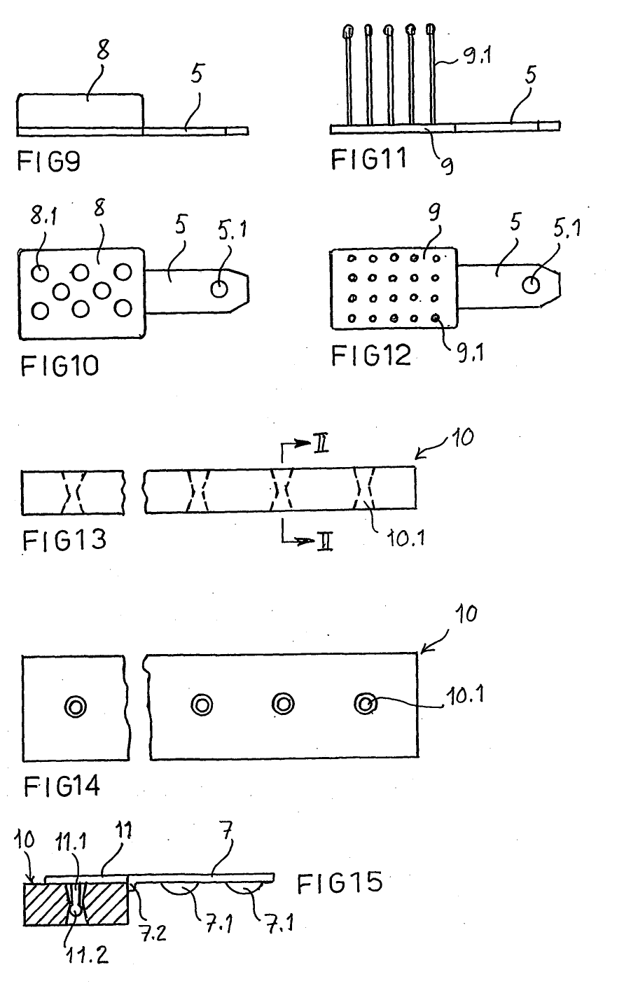

FIGS. 9 and 10 show a box 8 for cotton-wool rolls intended to be picked up with the aid of tweezers from holes 8.1 in the lid of the box. The box per se is already known and is not of disposable type. It enables rolls to be removed one at a time without all the rolls being extracted at once. In the example shown, the lower part of the box 8 is provided with a second attachment member in the form of a tongue 5 with a hole 5.1.

FIGS. 11 and 12 show a plate 9 on which micro-brushes a secured, protruding upwardly from the plate 9 with the brush part directed upwardly. The plate 9 is provided with a second attachment member in the form of a tongue 5 with a hole 5.1. The plate 9, brushes 9.1, and tongue 5 may also be manufactured in one piece out of plastic. Alternatively the plate 9 may be provided with holes for brushes 9.1 that are inserted into the holes separately.

FIGS. 13-15 show a base part 10 in an alternative embodiment in accordance with the invention, where each first attachment member consists of a hole 10.1 shaped like an hour-glass, and designed to receive a second attachment member in the form of an arm 11 with a pin 11.1, the lower part of which has an enlargement in the form of a ball 11.2. FIG. 15 shows a utensil in the form of a plate 7 with two cups 7.1 for liquid, similar to that shown in FIGS. 7 and 8, but provided with an arm 12 supporting the plate 7. The walls of both the hourglass-shaped hole 10.1 and the ball 11.2 are made of a resilient material that permits the pin 11.1 to be snapped fast in the hole 10.1 when it is pressed down into the hole. The interior of the plate 7 is provided with a rim 7.2 that rests against the base part 10 and prevents the arm 11 from turning in the hole 10.

1. A utensil holder for dental care for removing objects from dental-care utensils, preferably using one hand, comprising a base part designed to be placed on a substantially fixed surface, the base part having one or more first attachment members, each utensil being provided with a second attachment member characterized in that the first attachment member consists of a spring-loaded member which protrudes into a groove, and in that the second attachment member consists of a tongue provided with a stop which, when it is pushed into the groove is firmly locked by the spring-loaded member engaging with the stop.

2. A utensil holder as claimed in claim 1, wherein the first attachment member is arranged to cooperate with the second attachment member by means of a snap function.

3. A utensil holder as claimed in claim 1, wherein the spring-loaded member consists of a ball which is held depressed in the groove for the tongue with the aid of a spring, and in that the stop comprises a hole in the tongue.
